(19) United States
(12) Patent Application Publication
(10) Pub. No.: US 2013/0219687 A1
(43) Pub. Date: Aug. 29, 2013

(54) FASTENING METHOD

(71) Applicant: Chin-Han Wang, New Taipei City (TW)

(72) Inventor: Chin-Han Wang, New Taipei City (TW)

(21) Appl. No.: 13/853,450

(22) Filed: Mar. 29, 2013

Related U.S. Application Data
(63) Continuation-in-part of application No. 12/729,413, filed on Mar. 23, 2010.

(51) Int. Cl. F16B 19/04

(52) U.S. Cl. CPC F16B 19/04
USPC 29/505

(57) ABSTRACT

A fastening method is provided. The fastening method includes providing a first fastener member and a second fastener member. The first fastener member is provided with a base and at least one holder on an upper surface of the base. At least one through hole is formed on the base with a dovetail-shaped cross-section. The second fastener member is provided with a body, and is chiseled to form at least one deformable protrusion portion on the body. The protrusion portion is then inserted through the through hole from the bottom surface of the base to the upper surface of the base, and then extending beyond the upper surface of the base. An external force is applied on the protrusion portion to deform the protrusion portion for checking in the dovetail-shaped through hole, thus fixing the first fastener member and the second fastener member together.

### CROSS REFERENCE TO RELATED APPLICATIONS

This application is a continuation-in-part of U.S. patent application Ser. No. 12/729,413, filed on Mar. 23, 2010, which is incorporated herewith by reference.

### BACKGROUND OF THE INVENTION

1. Field of the Invention

The present invention relates generally to a fastening method for fastening two individual components with each other.

2. The Prior Arts

Most products are composed of multiple components or elements, and the components or elements are often fastened or assembled by a variety of fastening methods.

Taking the assembly of components of PC peripheral products for example, the components are fixed to a housing or a board of the product module, respectively, by different approaches. Typically, the approaches include configuring screw holes and providing screw holders for securing with screw bolts, or directly welding, riveting, engaging, or buckling the components for fixing.

However, the conventional approaches have the following disadvantages:

(1) Although very firm, the screwing connection or riveting connection requires addition cost for screw bolts or rivets, and further introduces the screwing or riveting process which is inconvenient and wastes time;

(2) The welding approach, e.g., spot welding or laser welding, when applied on a very thin housing or board, is usually very difficult and often generate high temperature melting holes on the housing or the board. Furthermore, the welded position of the housing or the board is heated to a high temperature and is likely to be oxidized. Moreover, the welding process often produces poisonous gas, which is harmful for human body and pollutes the environment; and

(3) The engaging connection and the buckling connection are convenient and quick. However, these approaches are usually not firm enough. Further, specific molds are usually required for producing the engaging or buckling structures. Unfortunately, the molds are often not easy to develop and cost much.

### SUMMARY OF THE INVENTION

Accordingly, a primary objective of the present invention is to provide a fastening method, which is cheap, convenient, environment friendly and can provide a firm connection, as a solution of the difficulties of the foregoing conventional approaches.

For achieving the foregoing objective and others, the fastening method provided by the present invention includes the following steps: providing a first fastener member; forming at least one through hole on the first fastener member through the upper surface and a bottom surface of the first fastener member; providing a second fastener member with a body having an upper surface; chiseling the upper surface of the second fastener member to form at least one deformable protrusion portion for correspondingly inserting through the through hole of the first fastener member; inserting the protrusion portion of the second fastener member through the through hole of the first fastener member; and, applying an external force on the protrusion portion to deform the protrusion portion, so that the deformed protrusion portion checks the through hole so as to fasten the first fastener member and the second fastener member together.

Specifically, the first fastener member includes a base and at least one holder. The holder is secured on an upper surface of the base. The base includes at least one through hole. The through hole is formed with a dovetail-shaped cross-section. The dovetail-shaped cross-section of the through hole has a width at the upper surface of the base greater than a width of the dovetail-shaped cross-section at the bottom surface of the through hole. The deformed protrusion portion checks and fills up the through hole with the dovetail-shaped cross-section, thereby enhancing the fastening between the first and second fastener member.

The protrusion portion of the second fastener member is obtained by a chiseling process. The protrusion portion is obtained by chiseling a certain length on the surface of the body of the second fastener member, and erecting the chiseled part of the body. Preferably, the second fastener member provided by the present invention made of metal materials.

The fastening method provided by the present invention is simple and convenient, and does not produce any waste, thus satisfying the low-carbon environmental protection requirement.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a flow chart showing the steps of the fastening method of the present invention;

FIG. 2 is a perspective view of a first fastener member provided according to an embodiment of the present invention;

FIG. 3 is a perspective view of a second fastener member provided according to an embodiment of the present invention;

FIG. 4 is a cross-sectional view illustrating a step of the fastening method according to an embodiment of the present invention;

FIG. 5 is a cross-sectional view illustrating a further step of the fastening method according to an embodiment of the present invention;

FIG. 6 illustrates another embodiment of the present invention; and

FIG. 7 shows the fastening between two components using the fastening method of the present invention.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

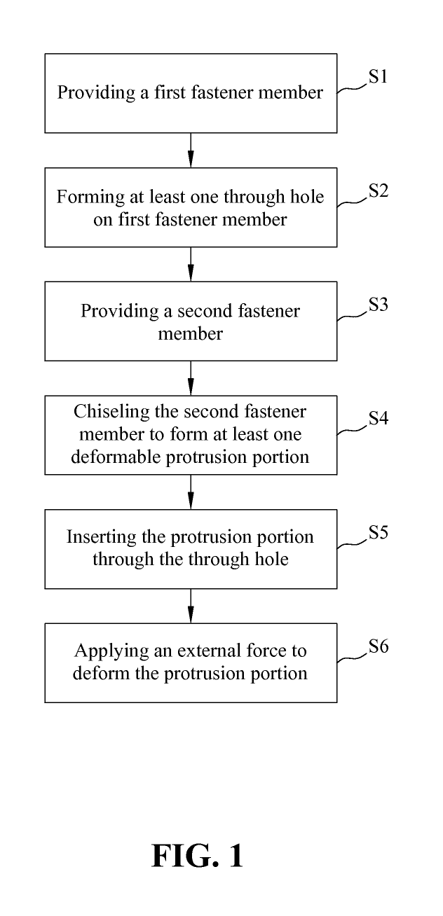

FIG. 1 is a flow chart showing the steps of the fastening method according to the present invention. First, in S1, a first fastener member is provided with a base and a holder on an upper surface of the base. Next, in S2, at lease one through hole is formed on the first fastener member through the upper surface and a bottom surface of the first fastener member. In S3, a second fastener member is provided with a body having an upper surface. Then, the upper surface of the second fastener member is chiseled to form at least one deformable protrusion portion in S4. The deformable protrusion portion is formed correspondingly for inserting through the through hole of the first fastener member. In S5, the protrusion portion is inserted through the through hole of the first fastener member. Finally, in S6, an external force is applied to the protrusion portion to deform the protrusion portion. The deformed protrusion portion checks the through hole so as to fasten the first fastener member and the second fastener member together.

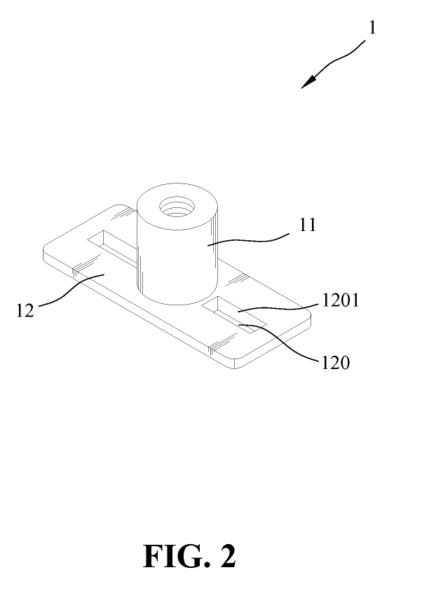

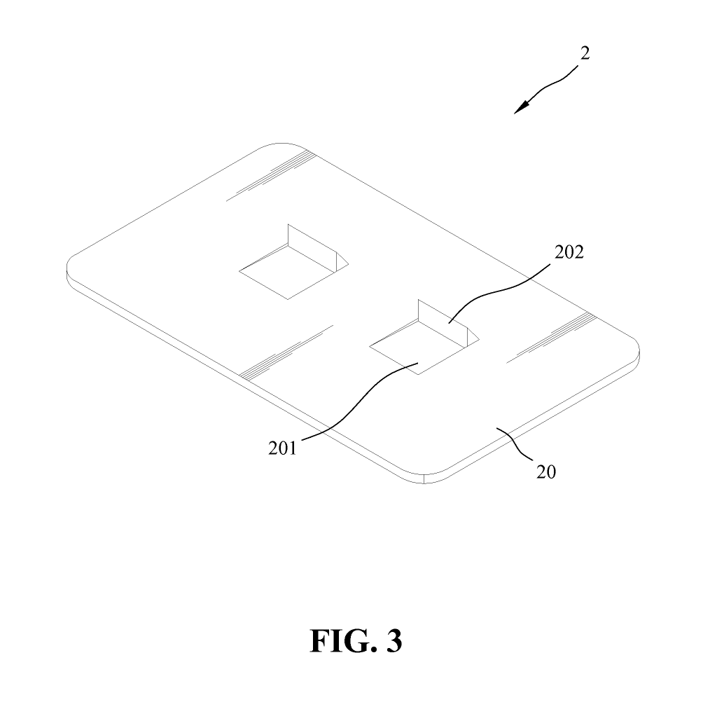

FIG. 2 is a perspective view of the first fastener member provided according to an embodiment of the present invention. FIG. 3 is a perspective view of the second fastener member according to an embodiment of the present invention.

Referring to FIGS. 2 and 3, the present invention provides a first fastener member 1 as shown in FIG. 2, and a second fastener member 3 as shown in FIG. 3. The first fastener member 1 for example can be fabricated by a molding process. As shown in FIG. 2, the first fastener member 1 includes a base 12, and a holder 11. The base 12 has an upper surface and a bottom surface. The holder 11 is secured on the upper surface of the base 12. The base 12 is configured with one or a plurality of through holes 120. As exemplified in FIG. 2, according to a preferred embodiment, the base 12 includes two through holes 120 symmetrically distributed at two lateral sides of the holder 11. Each through hole 120 has a dovetail-shaped cross-section. The dovetail-shaped cross-section of the through hole 120 has a width at the upper surface of the base 12 greater than a width of the dovetail-shaped cross-section at the bottom surface of the through hole 12. In other words, two opposite inner walls of the through hole 12 are configured as oblique planes 1201 as shown in FIG. 2. The holder 11 is adapted for connecting another component. For example, the holder 11 can be configured as a column-shaped member as shown in FIG. 2, and the column-shaped member is configured with an inner thread at an upper end of the column-shaped member. The screw hole can be threadly coupled with a screw bolt for connecting the other component.

As shown in FIG. 3, the second fastener member 2 includes a body 20 and at least one protrusion portion 202 configured at an upper surface of the body 20. A chisel is used to chisel a surface of the body 20 with a predetermined chiseling angle. The surface of the body 20 is then chiseled to form a chisel recess 201, and the original material of the recess is driven by the chisel to protrude above the surface of the body 20 and form the protrusion portion 202.

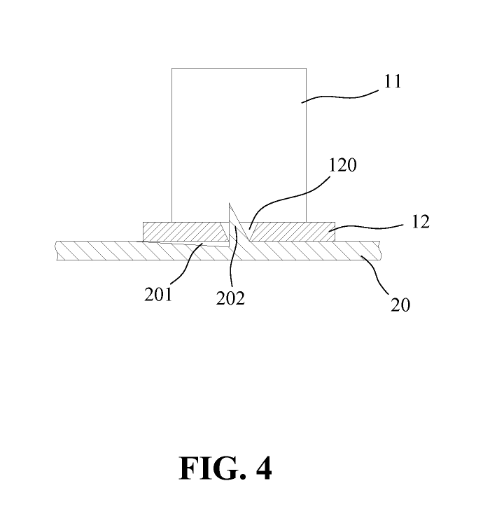

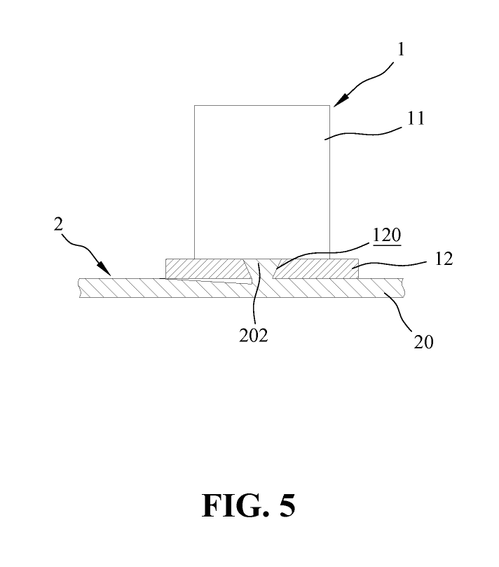

The protrusion portion 202 has a width substantially corresponding to a length of the through hole 120. Therefore, as shown in FIG. 4, the protrusion portion 202 is adapted for inserting through the through hole 120 from the bottom surface of the base 12 to the upper surface of the base 12, and then extending beyond the upper surface of the base 12. The protrusion portion 202 is adapted for being deformed for checking in the dovetail-shaped through hole 120, thus fixing the first fastener member 1 and the second fastener member 2 together. Preferably, the protrusion portion 202 is adapted for being deformed by a special tool, so that the deformed protrusion portion 202 can fill up the through hole 120 as shown in FIG. 5. In such a way, the deformed protrusion portion 202 checks on the oblique planes 1201 and blocks the through hole 120, so as to fasten the first fastener member 1 and the second fastener member 2 together.

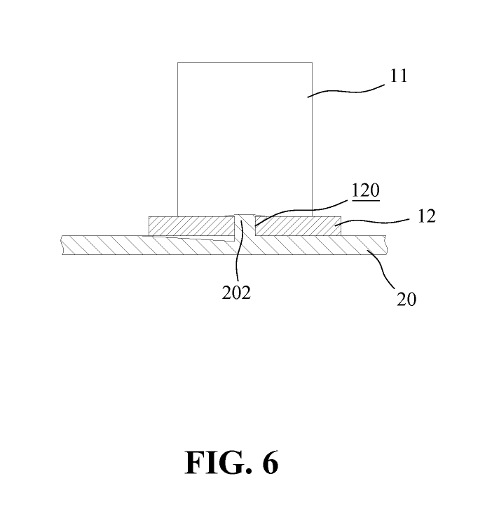

FIG. 6 illustrates another embodiment of the present invention. As shown in FIG. 6, the through hole 120 has a column-shaped cross-section, rather than dovetail-shaped cross-section of the foregoing embodiment. In accordance with this embodiment as shown in FIG. 6, the protrusion portion 202 is deformed, and the deformed protrusion portion 202 extends over the upper surface of the base 12 adjacent the through hole 120, so as to fasten the first fastener member 1 and the second fastener member 2 together.

Preferably, the second fastener member 2 is made of metal materials. To be more specific, using the chiseling method to form the protrusion portion on metal materials can save a lot of time and cost in comparison to using the molding or welding method.

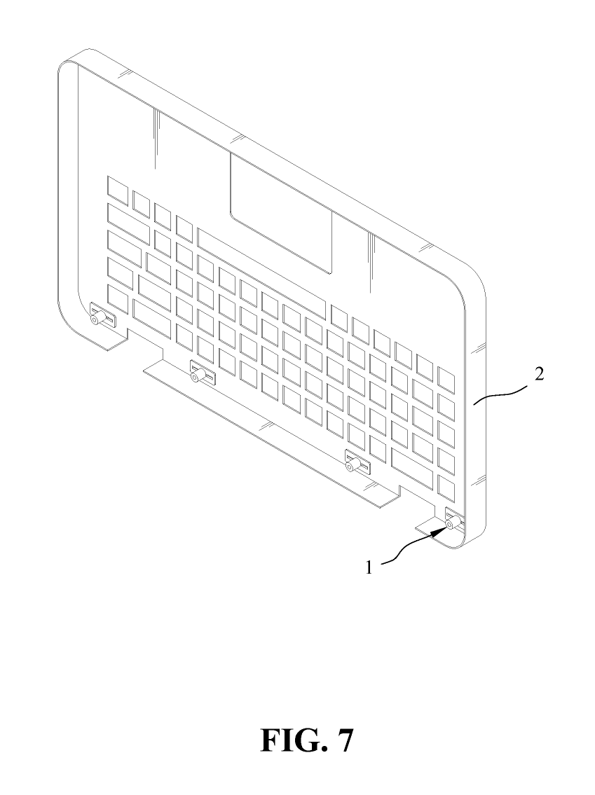

FIG. 7 shows the fastening between two components using the fastening method of the present invention. As exemplified in FIG. 7, the second fastener member 2 is presented as a housing member, e.g., a keyboard housing, in which a plurality of protrusion portions 202 are configured on the surface of the keyboard housing as discussed above. Then, a plurality of first fastener members 1 are fastened onto the keyboard housing by deforming these protrusion portions 202.

In summary, the present invention provides a fastening method having the following features and advantages:

(1) The present invention does not need any addition consumables, e.g., screw bolts, rivets, welding rods. The present invention is adapted to directly process the protrusion portion on the second fastener member, e.g., housing, and the depth of the recess is smaller than a half of the thickness of the second fastener member, and therefore the structural strength of the housing won't be affected.

(2) The first fastener member and the second fastener member can be conveniently fastened by applying an external force on, e.g., hammering, the protrusion portion, and therefore the assembling process is very quick and simple.

(3) The deformed protrusion portion fills up the dovetail-shaped through hole, and configures a firm checking status, while the evenness of the surface of the second fastener member can be maintained.

(4) The present invention saves material and time, and avoids unnecessary waste. The fastening method according to the present invention is cheap, simple and convenient, and does not produce any waste gas, thus satisfying the low-carbon environmental protection requirement.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A fastening method comprising:
providing a first fastener member with a base and a holder on an upper surface of the base;
forming at least one through hole on the first fastener member through the upper surface and a bottom surface of the first fastener member;
providing a second fastener member with a body having an upper surface;
chiseling the upper surface of the second fastener member to form at least one deformable protrusion portion for correspondingly inserting through the through hole of the first fastener member;
inserting the protrusion portion of the second fastener member through the through hole of the first fastener member; and
applying an external force on the protrusion portion to deform the protrusion portion, so that the deformed protrusion portion checks the through hole so as to fasten the first fastener member and the second fastener member together.

2. The fastening method as claimed in claim 1, wherein the through hole is formed with a dovetail-shaped cross-section, and the dovetail-shaped cross-section of the through hole has a width at the upper surface of the base greater than a width of the dovetail-shaped cross-section at the bottom surface of the through hole.

3. The fastening method as claimed in claim 1, wherein the holder provided is a column-shaped member having an inner thread configured at an upper end of the column-shaped member.

4. The fastening method as claimed in claim 3, wherein the base further comprises another through hole in addition, and the two through holes are structurally equivalent and symmetrically distributed at two lateral sides of the holder.

5. The fastening method as claimed in claim 1, wherein the second fastener member is made of metal materials.
